(19) United States
(12) Patent Application Publication
(10) Pub. No.: US 2023/0058417 A1
(43) Pub. Date: Feb. 23, 2023

(54) BATTERY PACK FOR BATTERY POWERED EQUIPMENT

(71) Applicants: BRIGGS & STRATTON, LLC, Wauwatosa, WI (US); Briggs & Stratton (Shanghai) International Trading Co., Ltd., Shanghai (CN)

(72) Inventors: Jeff Whitmore, Wauwatosa, WI (US); Ryan Hahn, Wauwatosa, WI (US); Nick Zeidler, Wauwatosa, WI (US); Ryan Jaskowiak, Mukwonago, WI (US); Kyle Harvey, Wauwatosa, WI (US); Shaoban Wu, Shanghai (CN); Haijiang Liu, Shanghai (CN); Yongkai Li, Shanghai (CN)

(73) Assignees: BRIGGS & STRATTON, LLC, Wauwatosa, WI (US); Briggs & Stratton (Shanghai) International Trading Co., Ltd., Shanghai (CN)

(21) Appl. No.: 17/797,549

(22) PCT Filed: Feb. 6, 2020
(86) PCT No.: PCT/CN2020/074409

§ 371 Date: Aug. 4, 2022

(51) Int. Cl. H01M 50/244; H01M 50/242; H01M 50/247

(52) U.S. Cl. CPC H01M 50/244; H01M 50/242; H01M 50/247

(57) ABSTRACT

A battery pack for powering equipment includes a core battery pack, a first housing, and a second housing. The core battery pack has a capacity of outputting a constant amount of current to deliver at least 1000 Watt-hours of energy. The core battery pack includes multiple battery cells and a mating interface. The mating interface is configured to selectively and electrically couple the core battery pack with an interface of a piece of power equipment or a charger. The first housing includes a handle and is attached to the core battery pack. The second housing is attached to the core battery pack and is configured to dampen a force experienced by the core battery pack upon an impact.

### BACKGROUND

The present invention generally relates to the field of indoor and outdoor power equipment, and in particular, to the field of battery powered indoor and outdoor power equipment.

### SUMMARY

One embodiment of the present disclosure includes a battery pack for powering equipment. The battery pack includes a core battery pack, a first housing, and a second housing. The core battery pack has a capacity of outputting a constant amount of current to deliver at least 1000 Watt-hours of energy. The core battery pack includes multiple battery cells and a mating interface. The mating interface is configured to selectively and electrically couple the core battery pack with an interface of a piece of power equipment or a charger. The first housing includes a handle and is attached to the core battery pack. The second housing is attached to the core battery pack and is configured to dampen a force experienced by the core battery pack upon an impact.

Another embodiment of the present disclosure is a core battery pack that includes a housing, multiple battery cells, multiple flexible O-rings, multiple spacers separating a first and a second face of the housing, multiple flexible pads, and a connector configured to selectively and electrically couple the core battery pack with an interface of a piece of power equipment or a charger. The multiple spacers are positioned within apertures of the housing. The multiple flexible pads are positioned between the multiple battery cells and an interior surface of the housing of the core battery pack. The multiple O-rings are positioned around the multiple spacers.

Another embodiment of the present disclosure is a battery pack including a core battery pack, a first housing of the battery pack, and a second housing of the battery pack. The core battery pack includes multiple battery cells and a core battery pack housing. The multiple battery cells are positioned within the core battery pack housing. The second housing includes a first bumper module attached to the core battery pack housing and a second bumper module attached to the core battery pack housing. The first bumper module includes a first shell and a first insert and the second bumper module includes a second shell and a second insert to dampen a force experienced by the core battery pack upon an impact.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a front view of a battery pack for use with various types of indoor and outdoor power equipment;

FIG. 2 is a perspective view of the battery pack of FIG. 1;

FIG. 3 is a front view of a core battery pack of the battery pack of FIG. 1;

FIG. 4 is a perspective view of a top portion and handle of a first housing of the battery pack of FIG. 1;

FIG. 5 is a front interior view of the top portion and handle of the first housing of the battery pack of FIG. 1;

FIG. 6 is a perspective interior view of a bottom of the housing of the core battery pack of FIG. 3;

FIG. 7 is a perspective view of a locking mechanism for the handle of the battery pack of FIG. 1;

FIG. 8 is an exploded view of a bumper module in a second housing of the battery pack of FIG. 1;

FIG. 9A is a perspective view of a bumper module including the flexible insert within the exterior shell shown in FIG. 8;

FIG. 9B is a perspective view of the flexible insert of the bumper module of FIG. 8;

FIG. 10 is a perspective view of a bumper module in a second housing of the battery pack of FIG. 1;

FIG. 11 is a rear cross-sectional view of the battery pack of FIG. 1;

FIG. 12 is a cross-sectional view of a bolt offset in a bottom portion of the battery pack of FIG. 1;

FIG. 13 is a cross-sectional view of the interior of the housing of the core battery pack of FIG. 3;

FIG. 14 is a perspective view of a cross-section of the housing of the core battery pack of FIG. 3;

FIG. 15 is a top perspective view of a portion of the core battery pack of FIG. 3 showing flexible pads within the housing of the core battery pack;

FIGS. 16A and 16B are perspective views of a cross-section of the core battery pack of FIG. 3 showing the housing case venting and draining;

FIGS. 17A and 17B are perspective views of a connection between the cables and the connector of the core battery pack of FIG. 3;

FIG. 18 is a perspective view of an equipment interface for coupling the battery pack of FIG. 1 to a piece of outdoor power equipment;

FIG. 19 is a perspective view of a charger for the battery pack of FIG. 1 that includes the equipment interface of FIG. 18;

FIG. 20 is a perspective view of connectors used in the core battery pack of FIG. 3 and equipment interface of FIG. 18; and

FIG. 21 is a perspective view of fasteners used for securing the first housing and the second housing of the battery pack of FIG. 1 to the housing of the core battery pack.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to figures generally, the battery assembly described herein is a removable and replaceable battery assembly, which can be used with various types of indoor and outdoor power equipment. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, portable generators, portable jobsite equipment, etc. Indoor power equipment includes floor sanders, floor buffers and polishers, vacuums, power tools, etc. Portable jobsite equipment includes portable light towers, mobile industrial heaters, and portable light stands.

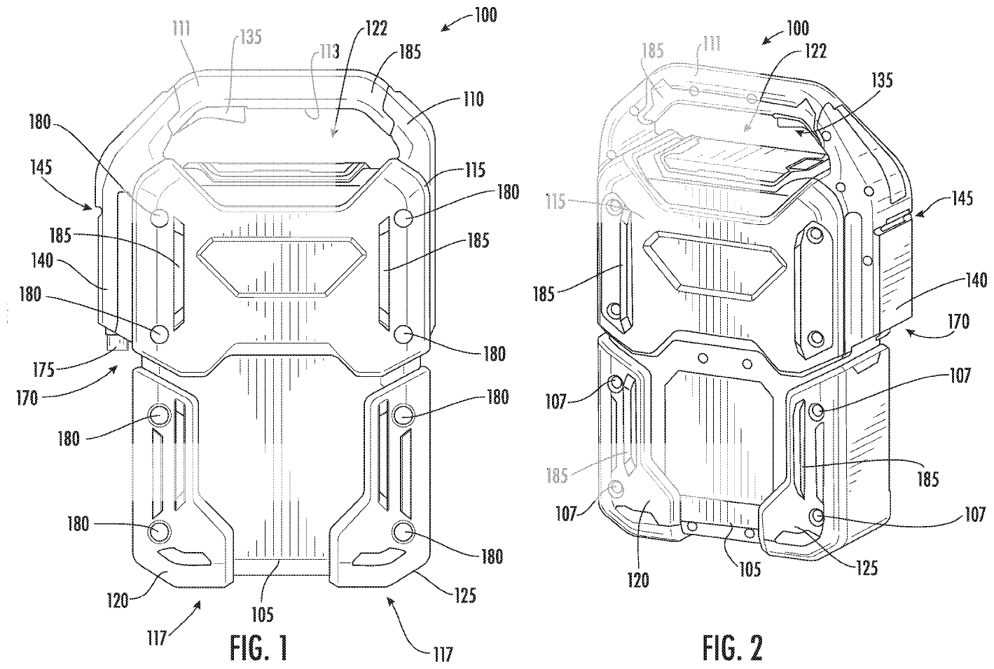

Referring to FIGS. 1 and 2, the battery pack 100 is shown, according to an exemplary embodiment. The battery pack 100 is removable and rechargeable. The battery pack 100 is configured to be coupled with an equipment interface mounted on a piece of equipment or inserted (e.g., dropped, lowered, placed) into a receiver including the equipment interface, that is integrated with a piece of equipment and/or a charging station. The battery pack 100 can be installed into a piece of equipment vertically, horizontally, or at any angle relative to vertical or horizontal. The battery pack 100 includes a core battery pack 105 and a housing with bumper modules as described below. The core battery pack 105 uses Lithium-ion battery cells. However, other battery chemistries may be used, such as nickel-cadmium (NiCD), lead-acid, nickel-metal hydride (NiMH), lithium polymer, etc. In some embodiments, the core battery pack 105 yields a voltage of approximately 48 Volts (V) and 1400 Watt-hours (Wh) of capacity. It is contemplated that core battery packs of other sizes may also be used. In other embodiments, it is contemplated that core battery packs of other sizes may also be used in order to provide a different voltage rating and a greater or less amount of W-hrs. In some embodiments, the battery pack 100 in total weighs less than approximately twenty-five pounds, allowing for ease of portability, removal, and replacement. In some embodiments, the battery pack 100 is also hot-swappable, meaning that a drained battery pack 100 can be exchanged for a new battery pack 100 without completely powering down connected equipment. As such, downtime of equipment operation between battery pack 100 exchanges is eliminated.

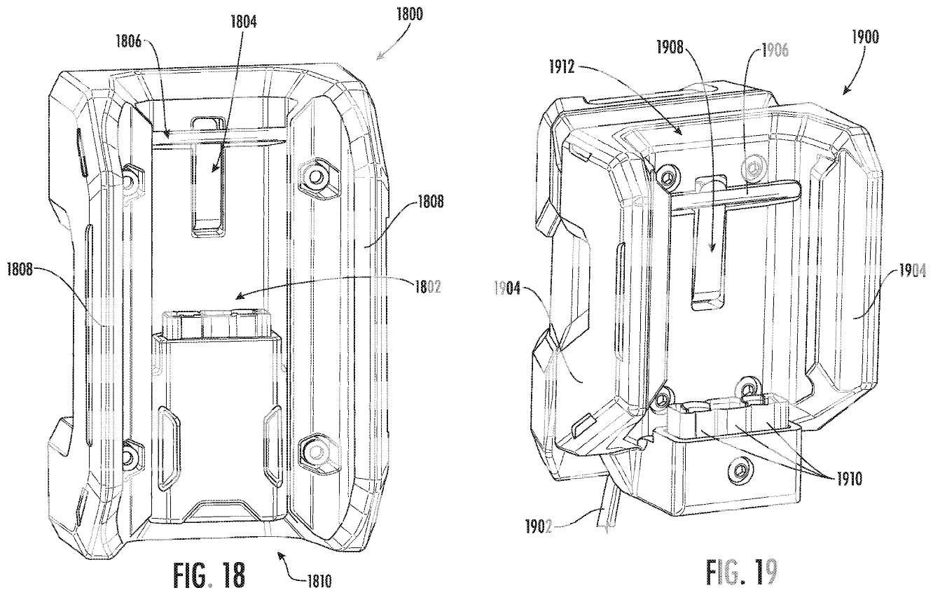

The battery pack 100 can be removed by an operator from a piece of equipment (e.g., from an equipment interface 1800 shown in FIG. 18) without the use of tools and recharged using a portable charger (e.g., portable charger 1900 (FIG. 19)) or charging station. In this way, the operator may use a second rechargeable battery having a sufficient charge to power equipment while allowing the first battery pack 100 to recharge. Additionally, the battery pack 100 can be used on various types of equipment including indoor, outdoor, and portable job site equipment. Due to its uniformity across various types of equipment, the battery pack 100 can also be used as part of a rental system, where rental companies who traditionally rent out pieces of equipment can also rent the battery pack 100 to be used on such equipment. An operator may rent a battery pack 100 to use on various types of equipment or vehicles the operator may own and/or rent and then return the battery pack 100 to be used by other operators on an as-needed basis. Furthermore, multiple battery packs 100 may be used in conjunction with each other to provide a sufficient amount of power to equipment that may require more than a single battery pack 100.

The battery pack 100 is configured to be selectively and electrically coupled to an interface of a piece of power equipment and/or a charger. The piece of equipment or charging station includes an equipment interface (e.g., equipment interface 1800 shown in FIG. 18) having electrical terminals that are selectively and electrically coupled to the battery pack 100 without the use of tools. For example, an operator may both insert (and electrically couple) and remove (and electrically decouple) the battery pack 100 from a piece of equipment (e.g., from terminals of the equipment interface) without the use of tools.

Still referring to FIG. 1, the battery pack 100 further includes a first, upper housing 115 coupled to the upper portion of the core battery pack 105, and a second, lower housing 117 coupled to a lower portion of the core battery pack 105. In some embodiments, the lower housing 117 includes bumper modules on each of the left and right sides. For example, the lower housing 117 includes a first bumper module 120 attached to the left side of the core battery pack 105 and a second bumper module 125 attached to the right side of the core battery pack 105. In other embodiments, the lower housing 117 includes a single bumper module that encompasses the entire bottom side of the core battery pack 105, rather than two separate bumper modules 120 and 125. In some embodiments, the upper housing 115 and the bumper modules 120, 125 of the lower housing 117 are coupled to the core battery pack 105 using fasteners 180 (e.g., bolts, screws). The upper housing 115 and the bumper modules 120 and 125 of the lower housing 117 provide protection to the core battery pack 105. In some embodiments, the upper housing 115 and the lower housing 117 are structured to absorb or limit the amount of force the core battery pack 105 endures from a fall, usage on a piece of equipment, etc. In some embodiments, the upper housing 115 includes a handle 110 for the battery pack 100. The upper housing 115 and the lower housing 117, including bumper modules 120 and 125, may form the overall housing for the battery pack 100 that substantially encompasses the housing of the core battery pack 105.

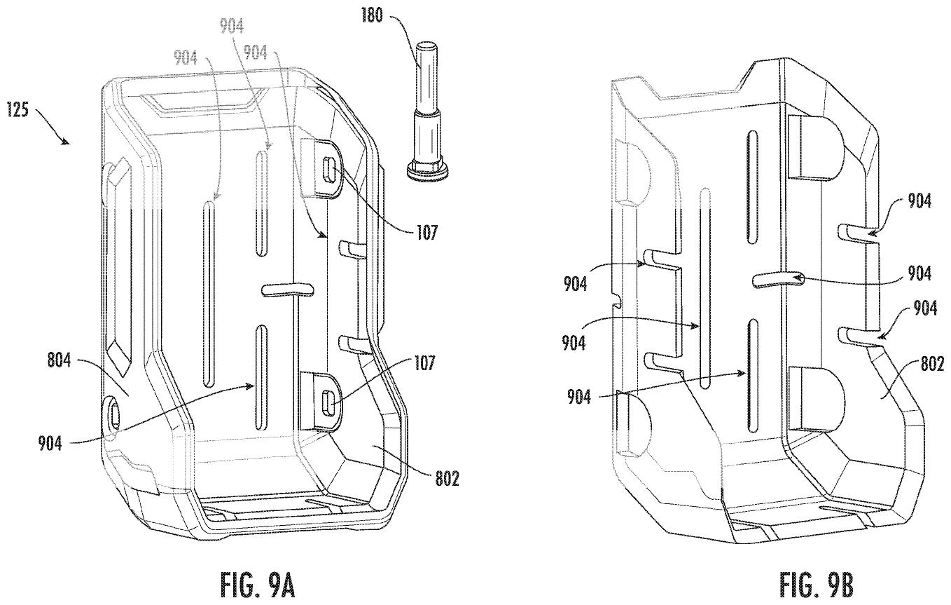

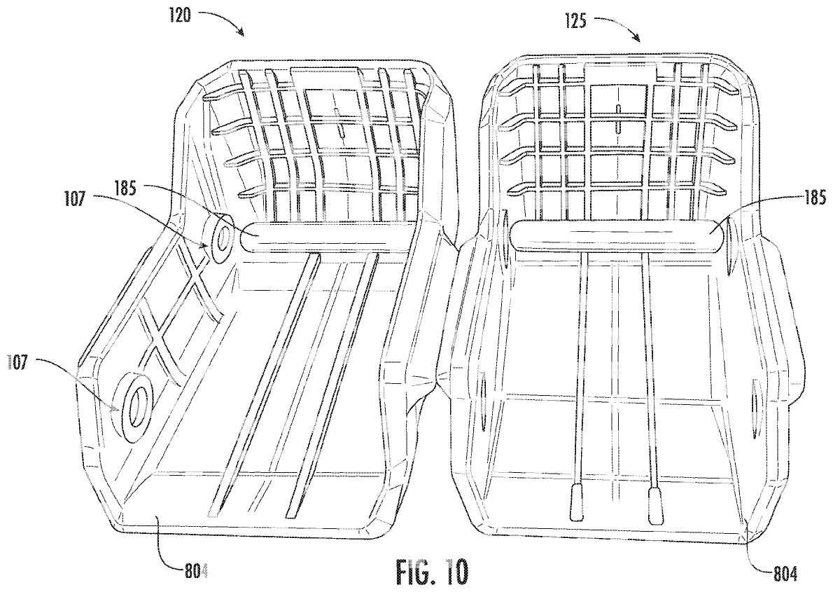

In some embodiments, the handle 110 and the upper housing 115 include flexible overmolding 185 to provide further protection to the core battery pack 105. The flexible overmolding 185 can help limit damage to the core battery pack 105 from external forces, such as forces exerted on the core battery pack 105 from a fall. The flexible overmolding 185 can be made from thermoplastic elastomer (TPE) overmolding and can have ribs 904 (FIGS. 9 and 10) to allow space to deflect and deform. In some embodiments, the flexible overmolding 185 are made out of the same material as the upper housing 115 and bumper modules 120 and 125. The upper housing 115 and bumper modules 120, 125 are exchangeable and customizable such that an operator or original equipment manufacturer may chose a different design and/or color based on the type or make and model of the equipment with which the battery pack 100 is to be used. Furthermore, the exchangeability of the upper housing 115 and the bumper modules 120, 125 allow the ability of operators to replace damaged portions. The upper housing 115 including the handle 110 and the bumper modules 120, 125 can be removed from the core battery pack 105. As such, in some embodiments, the battery pack 100 may not include the upper housing 115 and/or bumper modules 120, 125 and may be permanently mounted to a piece of equipment. One or more battery packs 100 can be used in a fixed mount environment. In addition, one or more battery packs 100 can be used in a removable and replaceable environment, such as with an electric vehicle. The battery packs 100 can be inserted into slots in an outdoor power vehicle and can be removed by an operator by grasping the handle 110 of each battery pack 100, unlocking the battery pack 100 from the slot by moving the release mechanism on the handle 110 (e.g., movable member 135), and pulling upward and outward until fully removed from the slot.

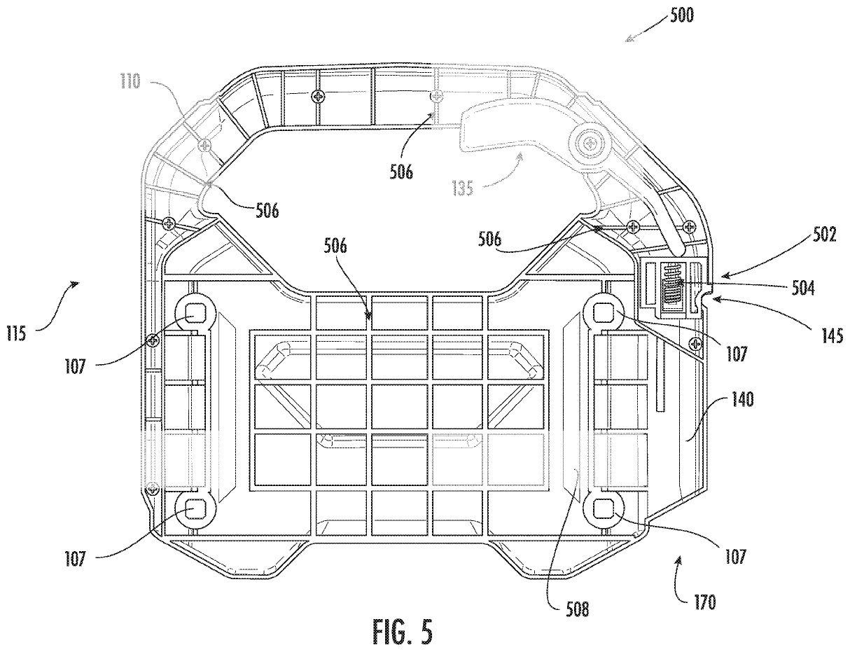

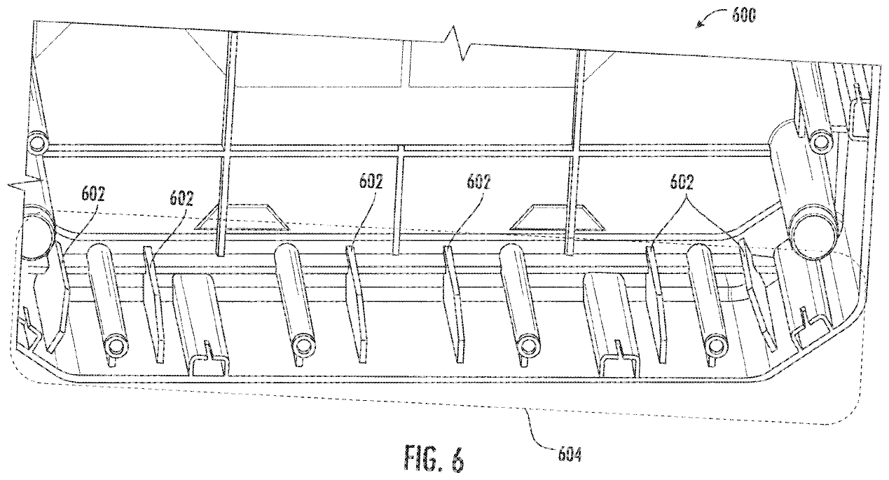

The upper housing 115 includes a slot 145 and a mating portion 140 including an opening 170 having one or more ports positioned therein. The ports are configured to mate with charging connectors on a charger (e.g., portable charger 1900 of FIG. 19) or an equipment interface (e.g., equipment interface 1800 of FIG. 18). The handle 110 includes an outer surface 111 and an inner surface 113 positioned nearer the core battery pack 105 than the outer surface 111. The inner surface 113 includes a release mechanism or movable member 135 configured to be operable by the operator to unlock and decouple the battery pack 100 from a charging station and/or a piece of equipment. When depressed, the movable member 135 moves inward toward the inner surface 113 and unlocks the battery pack 100 out of engagement with a respective feature on an interface of a piece of power equipment and/or a charger. In this way, when an operator grasps the handle 110, the operator can, at the same time and with the same hand, easily depress the movable member 135 to disengage the battery pack 100 from a piece of equipment or charging station. The handle 110 is also shown to include flexible overmolding 185, which may be the same material as the other flexible overmolding 185 on the upper housing 115, such as TPE overmolding. In some embodiments, TPE overmolding is also used on an interior interface between the handle 110 and housing of the core battery pack 105 to provide damping for the battery pack 100. The TPE overmolding may fill any gaps between the housing of the core battery pack 105 and the handle 110. The handle 110 may include a spring and shock-absorber system (e.g., trigger system 502 (FIG. 5)), which may permit movement of the handle 110 relative to the housing case of the core battery pack 105. When the battery pack 100 is attached to a piece of power equipment (e.g., via an equipment interface 1800 such as shown in FIG. 18), the spring inside the handle 110 can deliberately compress to secure the position of the connector of the core battery pack 105 to ensure both mechanical and electrical coupling to the piece of power equipment.

Still referring to FIG. 1, the core battery pack 105 further includes a user interface 122 configured to display various status and fault indications of the battery pack 100. The user interface 122 uses light-emitting diodes (LEDs), liquid crystal display, etc., to display various colors or other indications. The display of the user interface 122 can provide battery charge status, and can blink or flash battery fault codes. The display of the user interface 122 may also provide additional information about the battery pack 100 including condition, tool specific data, usage data, faults, customization settings, etc. For example, battery indications may include, but are not limited to, charge status, faults, battery health, battery life, capacity, rental time, battery mode, unique battery identifier, link systems, etc. The user interface 122 can be a customized version of a user interface tailored to a specific tool, use, or operator.

Referring, specifically to FIG. 2, a perspective view of the battery pack 100 shows the side of the battery pack 100 that couples to a charger or a piece of equipment in greater detail and the locations of apertures 107, according to one embodiment. In some embodiments, spacers and fasteners 180 are positioned in the apertures 107 to assemble the battery pack 100 and secure the upper housing 115 and bumper modules 120 and 125 to the core battery pack 105. The height of the battery pack 100 may be 446.045 millimeters (mm) in height from the bottom of the bumper modules 120 and 125 to the top surface of the handle 110. The width of the battery pack from the left side of the upper housing 115 to the right side of the upper housing 115 may be 292.6 mm. The thickness of the battery pack 100, with the upper housing 115 and bumper modules 120 and 125 covering the core battery pack 105, may be 128 mm. In other embodiments, different dimensions of the battery pack 100 can be contemplated. The overall weight of the battery pack 100 can be less than 25 pounds (lbs). The weight and the dimensions of the battery pack 100 allow an operator to easily carry the battery pack 100 with one hand and allow the battery pack 100 to be portable and removable without necessary tools.

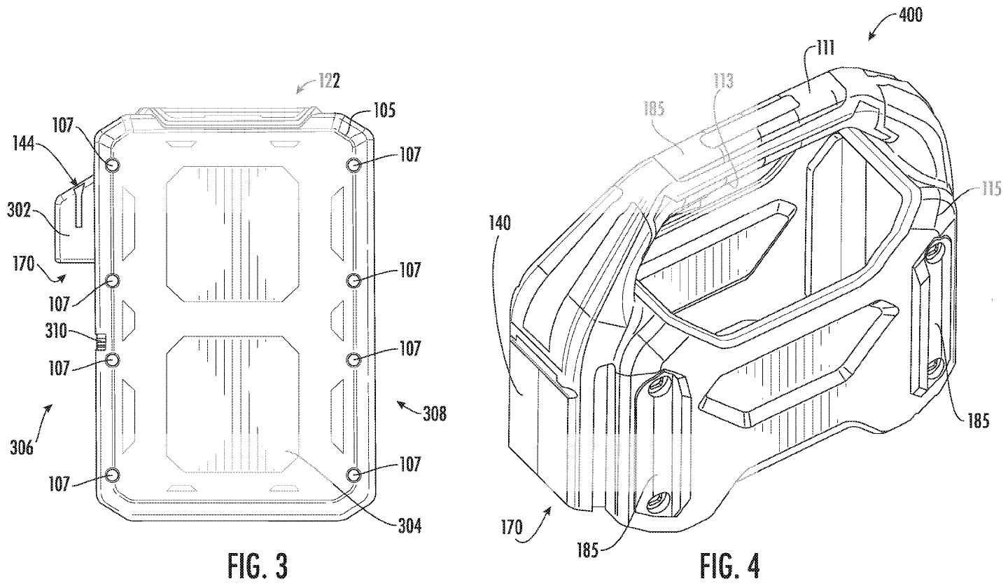

Referring to FIG. 3, the core battery pack 105 is shown in greater detail, according to one embodiment. The core battery pack 105 includes a front face 304, a rear face (not shown in FIG. 3), a left side 306, and a right side 308. The core battery pack 105 includes apertures 107 (e.g., through holes) extending from the front face 304 to the rear face of the core battery pack housing. Spacers (e.g., spacers 1502 (FIG. 15)) are inserted through the apertures 107, extending through the core battery pack 105 from the front face 304 to the rear face. The spacers separating the front face and the rear face of the core battery pack 105 may provide additional space above and below the battery cells within the housing of the core battery pack 105. The core battery pack 105 includes a connector portion 302, which includes inside one or more ports (e.g., ports 175 (FIG. 1)) configured to mate with charging connectors on a charger, charging station, or equipment interface for a piece of power equipment (e.g., outdoor power equipment, a power tool, etc.). The connector portion 302 is housed within the mating portion 140 of the upper housing 115 when the upper housing 115 is attached to the core battery pack 105. Accordingly, the ports are accessible through the mating portion 140 of the battery pack 100 as described above. In this way, the upper housing 115 may serve to protect the ports from damage due to being knocked during installation on a charging station and/or onto power equipment or serve to limit the amount of debris and/or liquid reaching or contacting the ports. The connector portion 302 includes a connector portion slot 144 configured to aid in guiding and/or positioning the connector portion 302 into the mating portion 140 of the upper housing 115. The core battery pack 105 also includes an inset portion 310 positioned on the left side 306 including an aperture (e.g., threaded hole) configured to receive a fastener (e.g., threaded fastener, bolt) to couple to a power connector for recharging the core battery pack 105.

Referring to FIG. 4, a perspective view 400 of a top portion of the upper housing 115 and handle 110 of the battery pack 100 is shown, according to an exemplary embodiment. The view 400 is shown to include the mating portion 140 of the battery assembly and the outer surface 111 and the inner surface 113 of the handle 110. In some embodiments, the flexible overmolding 185 is TPE overmolding secured to the outer surface of the upper housing 115 for the battery pack 100. The flexible overmolding 185 beneficially provides impact resistance and protection to the internal components (e.g., battery cells, collector plates, building management system (BMS) controller, wiring, etc.) of the core battery pack 105 of battery pack 100. For example, upon impact of the battery pack 100 on a hard surface from a fall, the flexible overmolding 185 may dampen forces experienced by the core battery pack 105 and limit damage to the battery cells within the core battery pack 105. In some embodiments, the flexible overmolding 185 encompasses the handle 110 of the upper housing 115, and may include more or less overmolding than shown in FIG. 4. For example, the flexible overmolding 185 may not extend down the sides of the upper housing 115. In another example, flexible overmolding 185 may be added in a middle portion of the upper housing 115, proximate where a logo may be positioned for the battery pack 100.

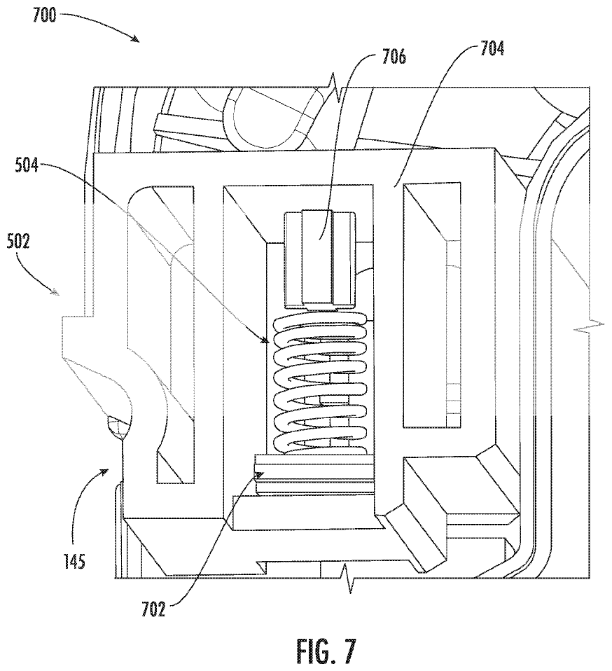

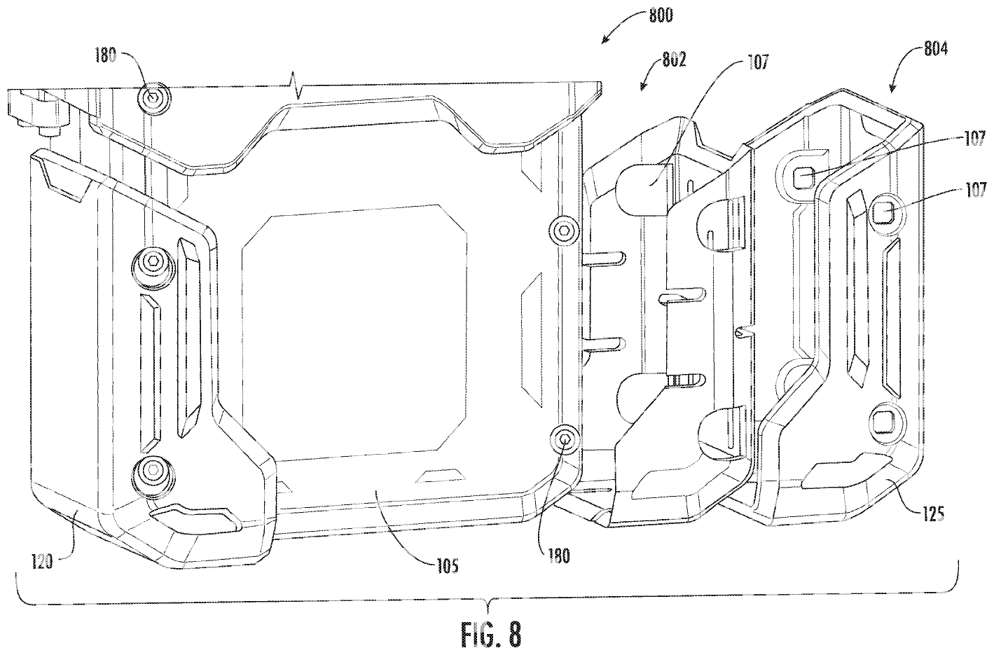

FIG. 5 shows a front interior view 500 of the upper housing 115, including the handle 110, of the battery pack 100, according to some embodiments. The view 500 includes trigger system 502 with spring 504 (shown in greater detail in FIG. 7, described below), ribs 506, and cutouts 508. In some embodiments, the cutouts 508 are spaces in the material of the upper housing 115 for TPE overmolding (e.g., flexible overmolding 185) to be inserted. The rubber insert may extend past the outer surface of the upper housing 115, like a flexible bumper, to cushion an impact proximate the upper portion of the battery pack 100. The ribs 506 may be 3 mm in thickness and used to reinforce the structure of the handle 110 and upper housing 115 of the battery pack 100. It is contemplated that the upper housing 115 may be structured to include more or less ribs 506 than shown in the embodiment of FIG. 5. Further, the ribs 506 may be structured in a different orientation, rather than in a square pattern, as shown in view 500, for example. In some embodiments, the upper housing 115 may be structured to include flexible overmolding 185 (FIG. 4) on an interior surface that interfaces with the core battery pack 105 between the cutouts 508, proximate a middle portion of the upper housing 115. The area of the handle 110 may include more ribs 506 than the other portions of the upper housing 115.

In some embodiments, the thickness of the upper surface of the handle 110 is 4 mm thick. The rest of the walls of the upper housing 115 for the battery pack 100 may only be 2.5 mm thick. In other embodiments, different thickness in the walls and surfaces of the upper housing 115 are also contemplated. The ribs 506 and the thicker wall near the handle 110 may provide the battery pack 100 with additional rigidity and reinforcement to protect the core battery pack 105 encompassed within the upper housing 115, improving overall robustness of the battery pack 100. Additionally, the upper housing 115 may include elastic overmolding (e.g., similar to or the same as flexible overmolding 185) in various locations that interface with the housing of the core battery pack 105. For example, each of the interior surfaces of the upper housing 115 that interface with corners of the battery pack 105 may include elastic overmolding. As such, the impact resistance of the core battery pack 105 may be improved to protect from impacts from any direction and/or to the battery pack 100 positioned in any orientation. The ribs 506 and elastic overmolding within the upper housing 115 can allow the battery pack 100 to absorb energy, caused by an impact from any direction or angle, to protect the components positioned within the core battery pack 105.

Referring to FIG. 6, perspective interior view 600 of a bottom of the housing of the core battery pack 105 is shown, according to one embodiment. In some embodiments, the ribs 602 are the same or similar as the ribs (e.g., ribs 506) used within the interior of the upper housing 115 of the battery pack 100. In other embodiments, the ribs 602 may be a different thickness than the ribs 506 described with reference to FIG. 5. View 600 demonstrates a 3D perspective of the ribs 602 in zone 604. The area indicated as zone 604 (shown as the area inside the green line) may be more susceptible to damage and impact compared to other areas of the core battery pack 105. As such, the ribs 602 may increase the robustness and protection of the core battery pack 105 to prevent damage to the internal components of the core battery pack 105. In some embodiments, the bottom of the housing of the core battery pack 105 may include more or less ribs 602 than shown in view 600.

FIG. 7 shows a perspective view 700 of the trigger system of FIG. 5 for the locking mechanism of the battery pack 100, according to some embodiments. The trigger system 502 may include a spring 504, a chamfer 702, and a movable component 704. When the correct amount of force is applied to the movable member 135, the sliding of movable component 704 is triggered and the battery pack 100 may be released from a locked position on a piece of equipment (e.g., on an equipment interface). In some embodiments, the spring 504 is inserted into a cross feature 706 on the movable component 704. In some embodiments, the chamfer 702 assists in applying force on the spring 504 to push the spring 504 into the correction position for trigger system 502. The trigger system 502 may be designed and positioned within the upper housing 115 of the battery pack 100 such that the structure of the movable component 704 may reinforce and support the housing of the handle 110.

Referring to FIG. 8, an exploded view 800 of the assembly of the bumper module 125 is shown, according to an exemplary embodiment. The exploded view 800 shows the core battery pack 105, the flexible insert 802, and the exterior shell 804. In some embodiments, the flexible insert 802 is made of a soft, rubber material, whereas the exterior shell 804 is made of a rigid, plastic material. The bumper module 125 includes the flexible insert 802 and the exterior shell 804 coupled to the housing of the core battery pack 105. In some embodiments, the flexible insert 802 is made of TPE material that increases impact resistance for the core battery pack 105 by damping the force felt by the core battery pack 105 from an impact. In some embodiments, the bumper modules 120 and 125 further dampen impacts to the core battery pack 105 due to freedom of movement provided by several bolt offsets. Fasteners 180 (e.g., bolts) may secure each of the bumper modules 120 and 125 to the core battery pack 105. In some embodiments, the fasteners 180 secure the bumper modules 120 and 125 to the core battery pack 105 via the apertures 107 in the flexible insert 802 and the exterior shell 804. In some embodiments, each rigid, exterior shell of the housing (e.g., upper housing 115) of the battery pack 100 includes a soft material, such as a TPE material, underneath. As such, the battery pack 100 may have augmented impact resistance and robustness. The thickness of the flexible inserts 802 may vary depending on the location of the flexible inserts 802 and the probability of that area of the battery pack 100 experiencing a direct impact during a fall. For example, the thickness of flexible inserts 802 may be greater on the bottom corners (e.g., bumper module 120 and bumper module 125) of the battery pack 100, or proximate the housing of the handle 110, than in the middle of the housing for the core battery pack 105. In other embodiments, the bumper modules 120 and 125 do not include a flexible insert 802. Instead, the bumper modules 120 and 125 may use overmolding (e.g., rubber overmolding) on the interior or exterior surfaces of the exterior shell 804.

Referring to FIGS. 9A and 9B, different perspective views of the components of the bumper modules of FIG. 8 are shown, according to exemplary embodiments. FIG. 9A shows the fitting of the flexible insert 802 within the exterior shell 804, according to some embodiments. The view in FIG. 9A also shows an example embodiment of cutouts 904 in the flexible insert 802. The cutouts 904 in the flexible insert 802 can allow the soft material to deform when the battery pack 100 experiences an impact on a lower bumper module (e.g., bumper module 125). In some embodiments, the exterior shell 804 has a wall thickness of 2.5 mm. In other embodiments, the exterior shell 804 has a different thickness, depending on how much impact resistance and deflection is desired for the battery pack 100. In some embodiments, the exterior shell 804 also includes TPE overmolding on the outside of the exterior shell 804 to provide further impact resistance. In some embodiments, the shape of the apertures 107 in the exterior shell 804 can prevent the fasteners 180 from rotating while securing the exterior shell 804 and the flexible insert 802 of the bumper modules 120 and 125 to the core battery pack 105. The flexible insert 802, shown in FIG. 9B, may be 5 mm thick and prevent more damage to the housing and the internal components of the core battery pack 105. The cutouts 904 may provide at least 1.5 mm of room for the flexible insert 802 to deform to reduce detrimental effects from an impact. The disclosed thicknesses are not meant to be limiting, and one can appreciate how the dimensions of the components may vary in other embodiments.

Referring to FIG. 10, the bumper modules 120 and 125 are shown, according to an exemplary embodiment. The view shown in FIG. 10 depicts the areas of the bumper modules 120 and 125 that directly interface with the core battery pack 105. In some embodiments, the bumper modules 120 and 125 include elastic ribs, such as flexible overmolding 185, to provide damping effects for the battery pack 100. For example, instead of a flexible insert 802, the interior surface of the exterior shell 804 is overmolded with flexible overmolding 185 in both horizontal and vertical directions. In some embodiments, the flexible overmolding 185 is the insert between the housing of the core battery pack 105 and the exterior shell 804 that provides damping for the core battery pack 105. The amount of flexible overmolding 185 may be greater and/or thicker in the corners of the bumper modules 120 and 125. The exterior shell 804 may also include rigid, plastic ribs on the interior surface of the exterior shell 804, as well as flexible overmolding 185. The bumper modules 120 and 125 may include more or less flexible overmolding 185 than shown as an example in FIG. 10. Furthermore, the exterior shells 804 shown in FIG. 10 may include rigid, plastic ribs or flexible overmolding 185 on the outer surface of the exterior shells 804.

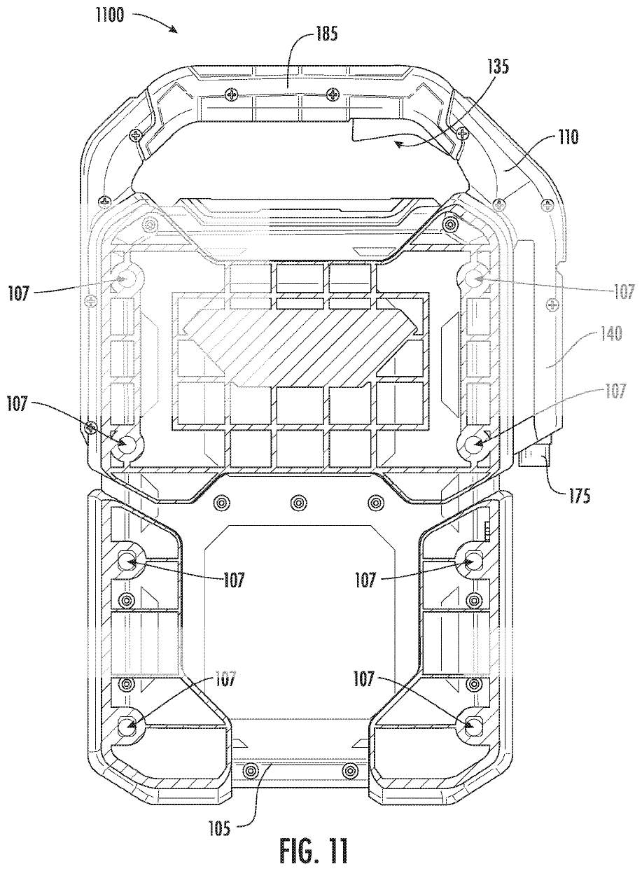

Referring to FIG. 11, a rear cross-sectional view 1100 of the battery pack 100 is shown, according to an embodiment. The view 1100 shows the flexible overmolding 185 encompassing the handle 110 and the movable member 135 for use in the trigger system of the battery pack 100. FIG. 11 shows the location of the apertures 107 in the core battery pack 105 for assembly of the battery pack 100. The view 1100 also includes the mounting portion 140 of the upper housing 115, covering the ports 175. The mounting portion 140 may significantly cover the opening to the battery pack 100 for the mating of the ports 175 to an equipment interface (e.g., equipment interface 1800) or portable charger. As such, it may be more difficult for debris to enter the core battery pack 105, while still providing air ventilation for the battery pack 100.

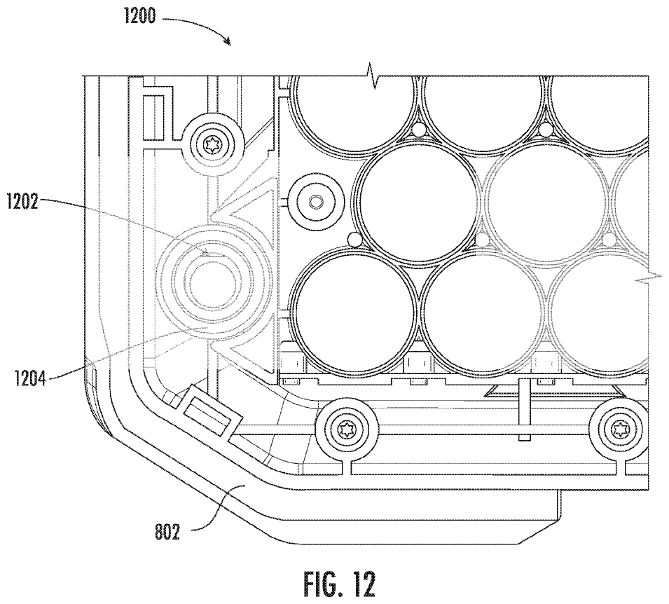

Referring now to FIG. 12, FIG. 12 shows a cross-sectional view 1200 of a bolt offset in a bottom portion of the battery pack 100, according to one embodiment. The view 1200 shows several cross sections of the battery cells within the core battery pack 105, the flexible insert 802 of a bumper module (e.g., bumper modules 120 and 125), and the exterior shell 804 of a bumper module. The flexible insert 802 is attached to the core battery pack 105 and positioned between the exterior shell 804 and the housing of the core battery pack 105. The view 1200 shows the bolt offset 1202 and a flexible O-ring 1204. In some embodiments, fasteners 180 (e.g., bolts) are positioned within the apertures 107. Spacers are also positioned within the apertures 107. The fasteners 180 and the spacers can have a different longitudinal axis to offset the fasteners, providing the bolt offset 1202. As such, by offsetting the fasteners 180, freedom of movement of the fasteners 180 and the bumper modules 120 and 125 may be increased. In some embodiments, the bolt offsets 1202 can be a 1.5 mm gap to allow the exterior shells 804 and flexible inserts 802 to further dampen an impact experienced by the battery pack 100. The bolt offsets 1202 for each fastener 180 of the battery pack 100 can also permit the handle 110 to dampen when there is a collision with an upper portion of the battery pack 100. In some embodiments, the bolt offset 1202 also allows a bumper around the bolt (e.g., flexible O-ring 1204) to move relative to the core battery pack 105, while still firmly securing the battery pack 100. In some embodiments, the freedom of movement provided by the bolt offset 1202 may reduce the damaging effects of impacts to the battery pack 100.

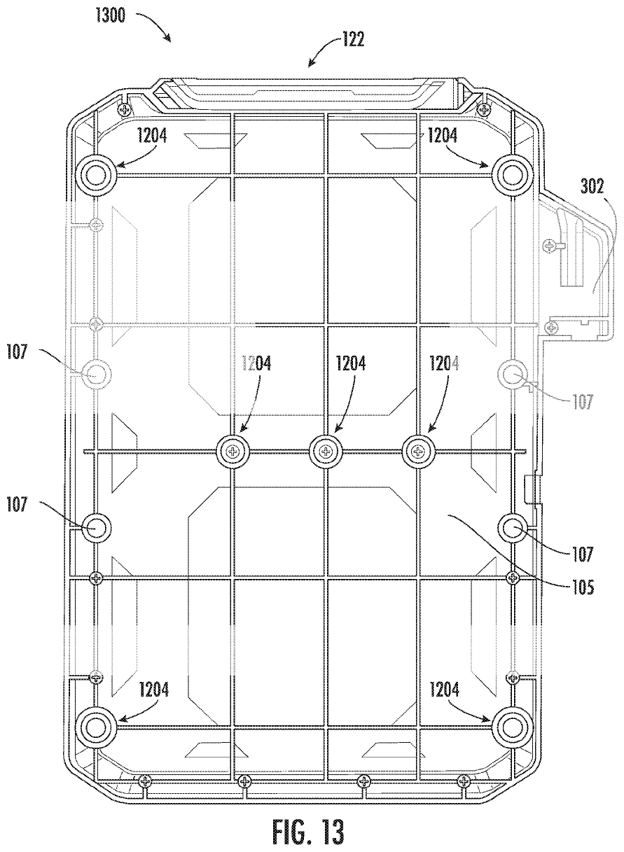

FIGS. 13-15 show perspective views of additional damping components (e.g., flexible O-rings 1204) inside of the core battery pack 105 of the battery pack 100, according to exemplary embodiments. Referring to FIG. 13 particularly, a cross-sectional view 1300 of the housing of the core battery pack 105 shows the locations of flexible O-rings 1204, for example. The locations of the flexible O-rings 1204 can be in each corner of the housing of the core battery pack 105 and three in the center of the core battery pack 105 on each side of the housing. As such, the core battery pack 105 may include fourteen total flexible O-ring 1204 inside of the core battery pack 105 to improve the impact resistance of the core battery pack 105. In other embodiments, more or less flexible O-rings 1204 may be used. The perspective view 1300 also shows the user interface 122, the apertures 107 for the fasteners 180 to assemble the core battery pack 105 to the upper housing 115 and the lower housing 117 of the battery pack 100, a connector portion 302 for the location of the ports (e.g., ports 175), and circuit boards 1302 (e.g., an Internet of Things (IOT) circuit board and a Near Field Communications (NFC) transmitter board). The flexible O-rings 1204 on each side of the housing for the core battery pack 105 can dampen the force of a collision and prevent damage to the internal components (e.g., battery cells, circuit boards 1302, electrical connector, wiring, etc.) of the core battery pack 105.

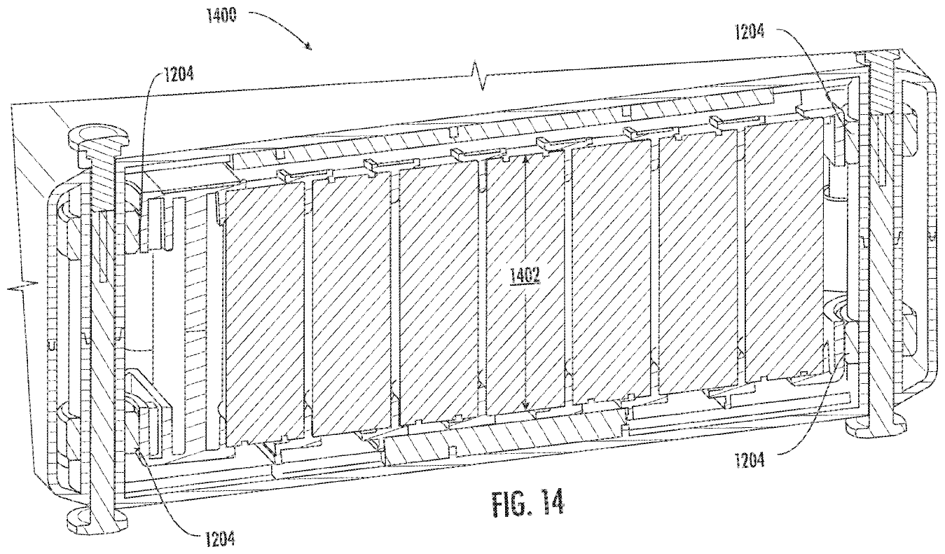

Referring now to FIG. 14 particularly, a perspective view 1400 of a cross-section of core battery pack 105 shows flexible pads inside of the core battery pack 105, in addition to the flexible O-rings 1204, for example. In some embodiments, the flexible pads 1402 are above and below the battery cells of the core battery pack 105. In some embodiments, the flexible pads 1402 are positioned between the battery cells and an interior surface of the housing of the core battery pack 105. The flexible pads 1402 can surround the battery cells to allow the internal components (e.g., battery cells) of the core battery pack 105 to be “floating” inside the housing of the core battery pack 105. The flexible pads 1402 can be silicone rubber pads next to collector plates of battery cells to provide cushioning between the housing case of the core battery pack 105 and the internal components of the core battery pack 105 (e.g., the battery cells, collector trays, collector plates, wiring, circuit boards, etc.). In some embodiments, silicone rubber pads may also be used in the core battery pack 105 to aid in thermal dissipation for the core battery pack 105. In other embodiments, the housing of the core battery pack 105 is overmolded with an aluminum plate as another means for dissipating heat from the core battery pack 105. Referring specifically to FIG. 15, a top perspective view 1500 depicting a portion of the core battery pack 105, along with flexible pads 1402 and flexible O-rings 1204, is shown, for example. In some embodiments, the view 1500 is the view of the core battery pack 105 if a front face of the housing for the core battery pack 105 was removed. The view 1500 shows the battery cells below each flexible pad 1402. As such, the flexible pads 1402 may be bumpers for the battery cells within the core battery pack 105 to dampen impacts to the core battery pack 105. The view 1500 also includes the flexible O-rings 1204 on spacers 1502 of the core battery pack 105 and in the middle of the core battery pack 105 between the battery cells. The two flexible O-rings 1204, one proximate the front face of the core battery pack 105 and one proximate the rear face of the core battery pack 105, can also be seen on one of the spacers 1502 in the bottom left corner of the core battery pack 105. In some embodiments, the damping structures (e.g., flexible pads 1402 and/or flexible O-rings 1204) within the core battery pack 105 may cover a greater area or may include more flexible pads 1402 and/or more flexible O-rings 1204 than shown in the perspective view 1500.

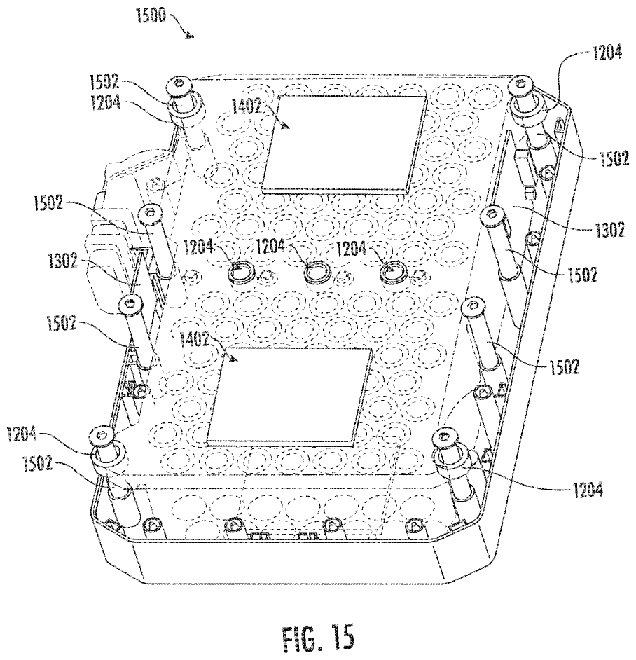

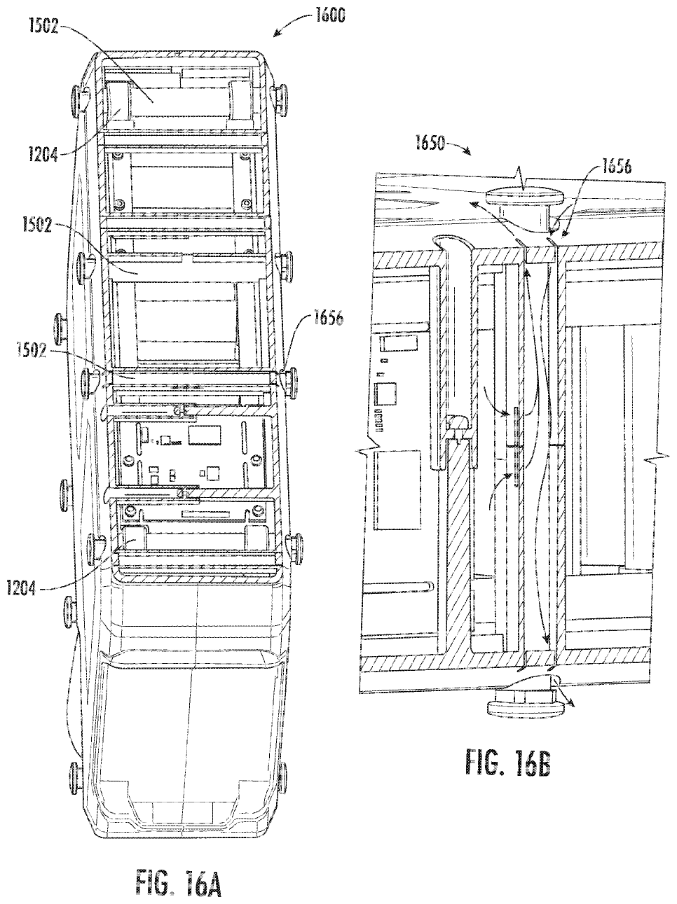

Referring now to FIG. 16A, a perspective view 1600 of a cross-section of the core battery pack 105 is shown, according to one embodiment. The perspective view 1600 is from a side of the core battery pack 105 and includes the fasteners 180, the flexible O-rings 1204 on the spacers 1502 of the core battery pack 105, and ventilation aperture 1656. Referring particularly to FIG. 16B, a zoomed-in, perspective view 1650 shows a close up of the ventilation aperture 1656. In some embodiments, the ventilation aperture 1656 is located on both a left side and a right side of each spacer 1502 in the core battery pack 105. The ventilation aperture 1656 may be a small pathway from the front face 304 of the core battery pack 105 to a rear face of the core battery pack 105. In some embodiments, the ventilation aperture 1656 allows allow air, water, or debris to leave the housing of the core battery pack 105. Vents or drains in the core battery pack 105 may be shielded by the housing (e.g., upper housing 115 and/or lower housing 117) of battery pack 100 to prevent entry of debris or water. In some embodiments, the battery pack 100 includes small apertures in the housing of the core battery pack 105 proximate the location of a BMS controller and beneath the handle 110. In some embodiments, the battery pack 100 includes small apertures in the housing of the core battery pack 105 proximate the outer edges and corners of the housing for the core battery pack 105 in order to increase ventilation.

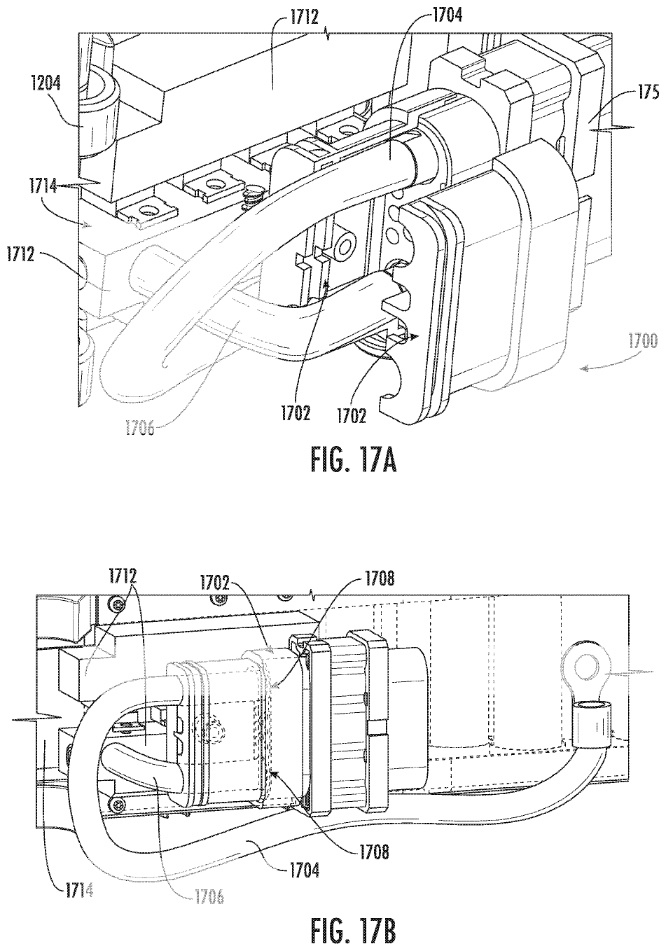

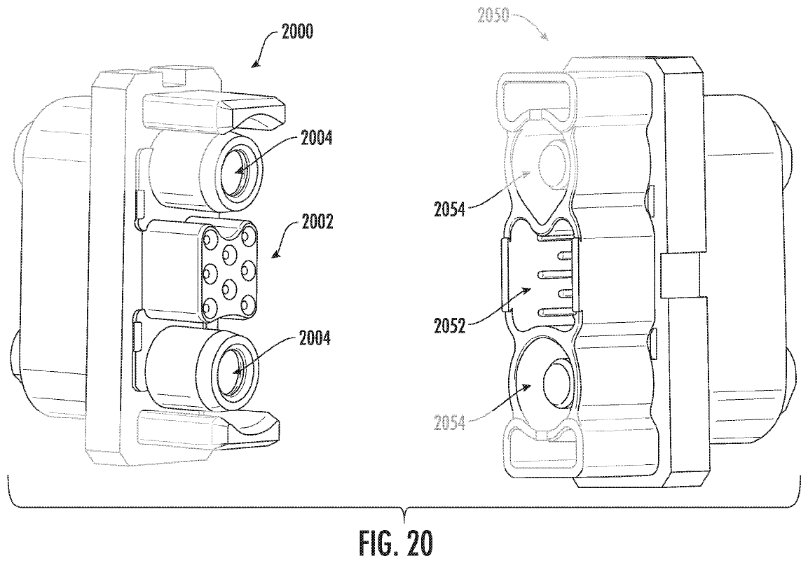

FIGS. 17A and 17B show a cable holder 1702 for reducing bias of the power cables within the core battery pack 105, according to some embodiments. Referring specifically to FIG. 17A, an exploded view 1700 of the cable holder 1702 shows the connection of the power cables 1704 and 1706 to the electrical connector (e.g., male pin connector 2050 (FIG. 20)) for coupling to a portable charger or equipment interface. The cable holder 1702 may provide straight routing of the power cables 1704 and 1706 in the core battery pack 105. In some embodiments, the cable holder 1702 has a straight guide that is configured to route the power cables 1704 and 1706 straight to decrease bias in the power cables 1704 and 1706. The cable holder 1702 can advantageously reduce bias caused by a quick turn of the power cable 1704 and power cable 1706 in the core battery pack 105. Referring to FIG. 17B, a zoomed-in view of the mating interface of the core battery pack 105 is shown, according to some embodiments. In some embodiments, the mating interface of the core battery pack 105 is configured to selectively and electrically couple the core battery pack 105 with an interface (e.g., equipment interface 1900 (FIG. 9)) of a piece of power equipment or charger. In some embodiments, the mating interface of the core battery pack 105 includes an electrical connector coupled to the cable holder 1702. The electrical connector may couple to power and communication ports of the interface of the power equipment or the charger, for example, via ports 175.

FIG. 17B also shows the connection interface 1708, within the cable guide 1702, between the power cables 1704 and 1706 and the electrical connector (e.g., male pin connector 2050 (FIG. 20)). The connection interface 1708 may include crimping of the power cables 1704 and 1706 to the electrical connector of the core battery pack 105. In some embodiments, the power cable 1704 can be connected to a shunt for the core battery pack 105. In some embodiments, metal-oxide semiconductor field-effect transistors (MOSFETs) 1714 are positioned in between the heat sinks 1712 and are used for switching signals of the core battery pack 105. The heat sinks 1712 can act to regulate the temperature of the core battery pack 105 by transferring the heat generated from the core battery pack 105 to a fluid medium (e.g., air), where the heat is then dissipated away from the core battery pack 105. In some embodiments, two rows of four MOSFETs are placed between the heat sinks 1712. In other embodiments, different configurations of the MOSFETs in the core battery pack 105 are contemplated. The cable holder 1702 coupled to the electrical connector with ports 175 may be positioned inside the connector portion 302 within the mating portion 140 of the upper housing 115.

Referring to FIG. 18, an equipment interface 1800 is shown, according to an exemplary embodiment. The equipment interface 1800 may be coupled to the ports 175 of the core battery pack 105 in order to provide power from the battery pack 100 to a piece of power equipment. In some embodiments, the equipment interface 1800 is on a side of the outdoor power equipment. The equipment interface 1800 may couple to a receiving side of the battery pack 100, such as the side of battery pack 100 with the mating portion 140. In other embodiments, a bottom receiver on the battery pack 100 couples the battery pack 100 to the equipment interface 1800 and a cord is used to tether the battery pack 100 to the equipment interface 1800 for electrical connection. The equipment interface 1800 includes two outer walls 1808 and a receptacle 1810 in-between the two outer walls 1808. The side of the battery pack 100 with ports 175 can slide into the receptacle 1810 in order to connect to and lock into place to power the piece of outdoor power equipment. The equipment interface 1800 includes male ports 1802 to mate with the ports 175 (e.g., within opening 170 on mating portion 140) on the battery pack 100 in an installed position of the battery pack 100 on the equipment interface 1800. In other embodiments, the equipment interface 1800 may include female ports instead of male ports, depending on the compatible mating interface of the core battery pack 105. In some embodiments, the male ports 1802 include two power ports and a port for data communications. The equipment interface 1800 also includes a movable member 1804 and a horizontal member 1806 that operate to couple the mating portion 140 of the battery pack 100 to the equipment interface 1800 in order to power the connected piece of equipment. The battery pack 100 is slid downward into the equipment interface 1800 until the male ports 1802 connect with the ports into the mating portion 140 of the battery pack 100 and the horizontal member 195 on the equipment interface 1800 is coupled with the slot 145 on the battery pack 100. The engagement of the slot 145 with the horizontal member 1806 prevents and/or limits the vertical movement of the battery pack 100 in or out of the equipment interface 1800. The equipment interface 1800 includes mounting hardware (e.g., fasteners inserted through through-holes on the equipment interface 1800) that enables the equipment interface 1800 to be mounted to (e.g., coupled with, affixed to, attached to) a piece of equipment. The equipment interface 1800 is mounted to a piece of power equipment and the battery pack 100 is removably inserted into the equipment interface 1800 without the use of tools to interface with and provide power to the piece of equipment.

Referring now to FIG. 19, a perspective view of a portable charger 1900 for recharging the battery pack 100 is shown, according to an exemplary embodiment. The portable charger 1900 can be plugged into the battery pack 100 by connecting to ports 175 and can plug into a wall outlet (e.g., via cord 1902) to provide power to the battery pack 100. The portable charger 1900 also includes two vertical walls 1904 with a receptacle 1912 in between the two vertical walls 1904. The side of the battery pack 100 is configured to slide into the receptacle 1912 and lock into place on the portable charger 1900. The portable charger 1900 can include male ports 1910 configured to mate with the ports 175 of an electric connector of the core battery pack 105 in an installed position of the portable charger 1900. The portable charger 1900 also includes a horizontal member 1906 and a movable member 1908 that operate together to couple the portable charger 1900 onto the mating portion 140 of the battery pack 100. In some embodiments, the connection interface of the portable charger 1900 for the battery pack 100 is the same or similar as the equipment interface 1800 as described with reference to FIG. 18. In some embodiments, the battery pack 100 may be fully charged in approximately 4 hours using the portable charger 1900.

Turning now to FIG. 20, a perspective view of connectors are shown, according to an exemplary embodiment. In some embodiments, male pin connector 2050 can be used in the equipment interface 1800 and the portable charger 1900. For example, the male ports 1802 of the equipment interface 1800 and the male ports 1910 of the portable charger 1900 may both have the same design as the male pin connector 2050. The male pin connector 2050 may include two power buds 2054 and eight data pins 2052 to couple a piece of power equipment (e.g., via equipment interface 1800) or charging equipment for the battery pack 100 (e.g., portable charger 1900) to the core battery pack 105 via the female socket connector 2000. In some embodiments, the female socket connector 2000 is used in the core battery pack 105 as an electrical connector with ports (e.g., ports 175 (FIG. 11)). In some embodiments, the female socket connector 2000 couples to power and communication ports of an interface of a piece of power equipment or charger. The female socket connector 2000 may include two power sockets 2004 and eight data sockets 2002 to receive pins from a male connector (e.g., the male pin connector 2050). The female socket connector 2000 may be coupled to a cable with sufficient wire length between female socket connector 2000 and the battery cells within the core battery pack 105 to allow for movement between the battery cells and female socket connector 2000. For example, in FIG. 17, the female socket connector 2000 is connected to the cable holder 1708, cable 1704, and cable 1706. Beneficially, having a relative degree of movement between the connectors and the battery cells of the core battery pack 105 prevents problems arising upon the core battery pack 105 absorbing some degree of force from an impact. In some embodiments, the power buds of the male pin connector 2050 have some freedom to move within the power sockets of the female socket connector 2000. The description of FIG. 20 is not meant to be limiting, and it should be understood that in other embodiments the male pin connector 2050 may be included in the core battery pack 105 and couples to the female socket connector 2000 of a portable charger 1900 instead of the scenario described with reference to FIG. 20.

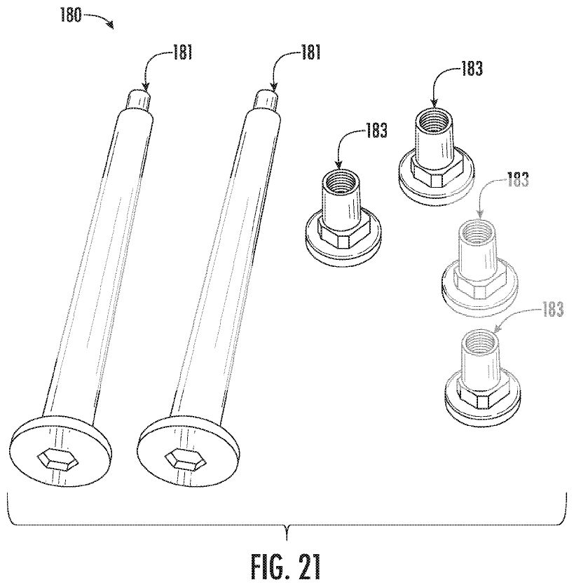

Referring to FIG. 21, a perspective view of fasteners 180 which may be used for the assembly of the battery pack 100 is shown, according to some embodiments. The fasteners 180 may include two components, a male component 181 and a female component 183 (e.g., a screw cap). The male component 181 includes a cylindrical portion that extends from the front face 304 to the rear face of the core battery pack 105. The cylindrical portion of the fastener 180 is positioned in the apertures 107 of upper housing 115, lower housing 117, and housing of the core battery pack 105. The longitudinal axis of the male component 181 may not align with the longitudinal axis of the apertures 107 and the spacers 1502 of the battery pack 100. The misaligned axes of the fasteners 180, apertures 107, and spacers 1502 can allow the fasteners 180 freedom of movement to damp from an impact to the battery pack 100 from any direction or angle. The female component 183 couples to the male component 181, for example, by tightening the female component 183 with a wrench. In other embodiments, the female component 183 of the fasteners 180 may include the cylindrical portion that is positioned with the apertures 107 and the spacers 1502. The fasteners 180 can be utilized for securing the upper housing 115 and the lower housing 117 of the battery pack of FIG. 1 to the housing of the core battery pack 105. The fasteners 180 may also be utilized to assemble a core battery pack 105 that does not have impact protection from an upper housing 115 and a lower housing 117.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that certain passages of this disclosure can reference terms such as “first” and “second” in connection with side and end, etc., for purposes of identifying or differentiating one from another or from others. These terms are not intended to merely relate entities (e.g., a first side and a second side) temporally or according to a sequence, although in some cases, these entities can include such a relationship. Nor do these terms limit the number of possible entities (e.g., sides or ends) that can operate within a system or environment.

The terms “coupled” and “connected” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

1. A battery pack for powering equipment comprising:
a core battery pack, the core battery pack having a capacity of outputting a constant amount of current to deliver at least 1000 Watt-hours of energy, the core battery pack including:
a plurality of battery cells; and
a mating interface configured to selectively and electrically couple the core battery pack with an interface of a piece of power equipment or a charger; and
a housing including:
a first housing comprising a handle, the first housing attached to the core battery pack; and
a second housing attached to the core battery pack and configured to dampen a force experienced by the core battery pack upon an impact.

2. The battery pack of claim 1, wherein the battery pack weighs less than twenty-five pounds.

3. (canceled)

4. The battery pack of claim 3, wherein the second housing includes a first bumper module and a second bumper module, and wherein the first bumper module comprises a first shell and a first insert, and wherein the second bumper module comprises a second shell and a second insert.

5. The battery pack of claim 4, wherein the first insert is positioned between the first shell and the core battery pack and the second insert is positioned between the second shell and the core battery pack.

6-7. (canceled)

8. The battery pack of claim 1, wherein the core battery pack comprises a plurality of flexible pads, the flexible pads positioned between the plurality of battery cells and an interior surface of the housing.

9. The battery pack of claim 1, wherein the core battery pack comprises a plurality of spacers in the housing, the plurality of spacers separating a first face and a second face of the housing to provide additional space above and below the plurality of battery cells, and wherein the plurality of spacers are positioned within apertures of the housing.

10. The battery pack of claim 9, wherein the battery pack comprises a plurality of fasteners positioned within the apertures, wherein the plurality of spacers and the plurality of fasteners have different longitudinal axes to offset the plurality of fasteners, and wherein the second housing includes a first bumper module and a second bumper module and the first bumper module and the second bumper module dampen impacts due to freedom of movement provided by the offsetting of the plurality of fasteners.

11. The battery pack of claim 1, wherein the handle comprises a spring in a trigger system that permits movement of the handle relative to the housing when the battery pack is not coupled to the interface of the piece of power equipment or charger.

12-13. (canceled)

14. A core battery pack comprising:
a housing;
a plurality of battery cells;
a plurality of flexible O-rings;
a plurality of spacers separating a first and a second face of the housing and positioned within apertures of the housing;
a plurality of flexible pads; and
a connector configured to selectively and electrically couple the core battery pack with an interface of a piece of power equipment or a charger;
wherein the plurality of flexible pads are positioned between the plurality of battery cells and an interior surface of the housing; and
wherein the plurality of flexible O-rings are positioned around the plurality of spacers.

15. The core battery pack of claim 14, wherein the housing of the core battery pack is attached to a first bumper module and a second bumper module, the first and second bumper modules being configured to provide impact resistance for the core battery pack.

16. The core battery pack of claim 15, wherein the first bumper module comprises a first shell and a first insert, and wherein the second bumper module comprises a second shell and a second insert, and wherein the first insert is positioned between the first shell and the core battery pack and the second insert is positioned between the second shell and the core battery pack.

17-18. (canceled)

19. The core battery pack of claim 15, wherein a plurality of fasteners are positioned within apertures of the housing, wherein the plurality of spacers and the plurality of fasteners have different longitudinal axes to offset the plurality of fasteners, and wherein the first bumper module and the second bumper module dampen impacts to the core battery pack due to freedom of movement provided by the offsetting of the plurality of fasteners.

20. The core battery pack of claim 14, wherein the plurality of spacers provide space above and below the plurality of battery cells.

21. The core battery pack of claim 20, wherein the plurality of flexible pads are positioned between the plurality of battery cells and an interior surface of the housing of the core battery pack.

22. (canceled)

23. The core battery pack of claim 14, wherein the connector couples to a cable holder having a straight guide configured to route power cables within the core battery pack straight to decrease bias in the power cables.

24. A battery pack comprising:
a core battery pack, the core battery pack including a plurality of battery cells and a core battery pack housing, the plurality of battery cells positioned within the core battery pack housing;
a first housing of the battery pack; and
a second housing of the battery pack, the second housing including a first bumper module attached to the core battery pack housing and a second bumper module attached to the core battery pack housing;
wherein the first bumper module includes a first shell and a first insert and the second bumper module includes a second shell and a second insert to dampen a force experienced by the core battery pack upon an impact.

25. The battery pack of claim 24, wherein the first housing of the battery pack is an upper housing and is integrated with a handle of the battery pack, and wherein the first housing includes a plurality of ribs on an interior surface of the first housing.

26. The battery pack of claim 25, wherein the plurality of ribs are made of a flexible material and include a plurality of gaps between the plurality of ribs to allow the flexible material to deform upon impact.

27. The battery pack of claim 25, further comprising a plurality of fasteners and a plurality of spacers that are positioned within apertures of the core battery pack housing, and wherein the plurality of spacers and the plurality of fasteners have different longitudinal axes to offset the plurality of fasteners.

28. The battery pack of claim 27, wherein a flexible O-ring is positioned around the plurality of spacers, and wherein the offsetting of the plurality of fasteners provides freedom of movement to dampen forces experienced by the core battery pack upon an impact.
